(19) United States
(12) Patent Application Publication
(10) Pub. No.: US 2008/0024023 A1
(43) Pub. Date: Jan. 31, 2008

(54) Fan for vehicle and its motor

(75) Inventors: Chen-Mo Jiang, Taoyuan Hsien (TW); Chung-Kai Lan, Taoyuan Hsien (TW); Hung-Chi Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/819,637

(22) Filed: Jun. 28, 2007

(30) Foreign Application Priority Data
Jul. 28, 2006 (JP) 095127661

(51) Int. Cl. H02K 5/04; F04B 17/03; H02K 5/167

(52) U.S. Cl. 310/89; 310/68 R; 310/90; 417/410.1

(57) ABSTRACT

A motor includes a stator and a rotor. The stator has a magnetically conductive element. The rotor has a shaft and a magnetic element. The shaft penetrates through the magnetic element and the magnetically conductive element. The magnetic element is disposed corresponding to the magnetically conductive element. The stator and rotor are disposed within a closed space, and the shaft protrudes from the closed space. A fan for a vehicle is also disclosed.

### BACKGROUND OF THE INVENTION

1. Field of Invention

The invention relates to a motor and in particular, to a fan with said motor for a vehicle.

2. Related Art

Motors function to transform electricity to mechanical energy and are utilized in conjunction with many mechanical structures, such as fans. Nowadays, there are many kinds of motors available, divided into inner-rotor type motors and outer-rotor type motors, which have their rotors disposed on the inside or outside of the motors, respectively.

As shown in FIG. 1, a conventional outer-rotor type motor 1 includes a base 10, a rotor 11, a stator 12 and a circuit board 13. The base 10 includes a barrel 101 and at least one bearing 102 disposed in the barrel 101. The rotor 11 includes a shaft 111, a magnetically conductive shell 112 and a magnet 113. The shaft 111 is embedded in the magnetically conductive shell 112 and is inserted through the barrel 101 and the bearing 102. The magnet 113 is disposed around the inner wall of the magnetically conductive shell 112.

The stator 12 includes a plurality of windings 121, which are connected to the barrel 101 and disposed corresponding to the magnet 113. The circuit board 13 covers and connects to the barrel 101. In addition, the circuit board 13 is disposed on the bearing base 10 and is electrically connected to the windings 121. The circuit board 13 is capable of controlling the current direction of the windings 121 to produce magnetic interaction with the magnet 113 of the rotor 11. Accordingly, the rotor 11 can be driven to rotate.

However, the outer-rotor type motor 1 has many assembling gaps between its components so that the structure of the outer-rotor type motor 1 is not airtight, which results in poor protection of the internal components. For example, there are many gaps G existing between the rotor 11 and the bearing base 10. Thus, debris or vapor may easily enter the outer-rotor type motor 1 through the gaps G to damage components of the motor 1 and decrease the reliability and lifespan of the outer-rotor type motor 1.

Therefore, it is an important subject to provide an outer-rotor type motor with good airtightness to effectively protect the inner components of the motor, and further increasing the reliability and lifespan of the motor.

### SUMMARY OF THE INVENTION

In view of the foregoing, the invention is to provide a motor with good airtightness and a fan using the motor.

To achieve the above, a motor of the invention includes a stator and a rotor. The stator has a magnetically conductive element. The rotor has a shaft and a magnetic element. The magnetic element is disposed corresponding to the magnetically conductive element. The stator and rotor are disposed within a closed space. The shaft is inserted through the magnetic element and the magnetically conductive element, and protrudes out of the closed space.

To achieve the above, a fan of the invention includes a motor and an impeller. The motor has a stator and a rotor. The stator has a magnetically conductive element. The rotor has a shaft and a magnetic element. The magnetic element is disposed corresponding to the magnetically conductive element. The stator and rotor are disposed within a closed space. The shaft is inserted through the magnetic element and the magnetically conductive element, and protrudes out of the closed space. The impeller is coupled to the shaft.

As mentioned above, the stator, rotor and driving device of the motor of the invention are disposed in a closed space, which is composed of a housing. Compared with the prior art, the motor of the invention is capable of protecting inner components of the motor due to its airtightness, thus further increasing its reliability and lifespan.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional motor;

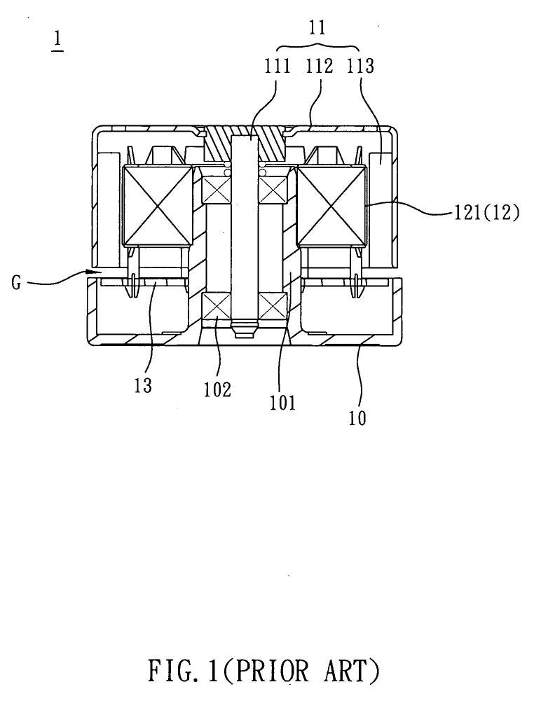

FIG. 2 is an exploded diagram of a motor according to an embodiment of the invention;

FIG. 3 is a sectional diagram of the assembled motor of FIG. 2; and

FIG. 4 is a schematic diagram of a fan according to the embodiment of the invention.

### DETAILED DESCRIPTION OF THE INVENTION

The present invention will be apparent from the following detailed description, which proceeds with reference to the accompanying drawings, wherein the same references relate to the same elements.

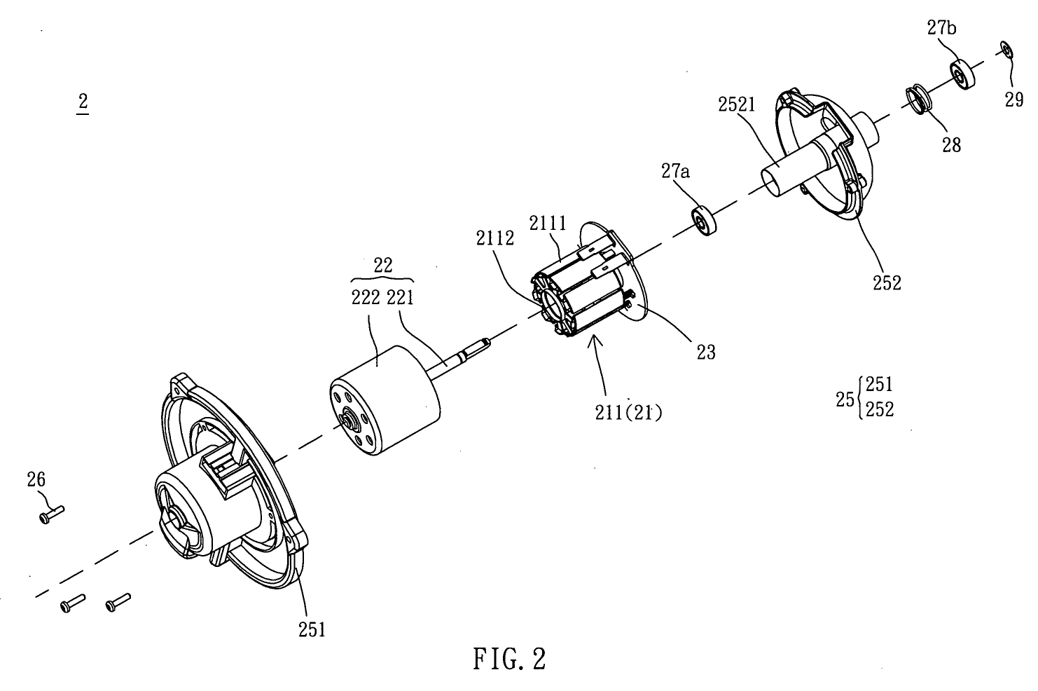

FIG. 2 is an exploded diagram of a motor 2 according to an embodiment of the invention. The motor 2 includes a stator 21, a rotor 22 and a driving device 23.

The stator 21 has a magnetically conductive element 211. Herein, the magnetically conductive element 211 has at least one silicon steel sheet 2111 and at least one winding 2112, which is wound around the silicon steel sheet 2111. The driving device 23 is electrically connected with the magnetically conductive element 211 and has a circuit board, which is used to control the magnetically conductive element 211, especially the current direction of the winding 2112, to produce an alternating electric field. Furthermore, the rotor 22 includes a shaft 221 and a magnetic element 222. The shaft 221 is connected to and is inserted through the magnetic element 222. Herein, the shaft 221 is embedded in the magnetic element 222.

The motor 2 further includes a first housing 251 and a second housing 252. In this embodiment, the first housing 251 and the second housing 252 can be made of metal or plastic, and they can be assembled each other by wedging, engaging, adhering or locking. In the embodiment, the first housing 251 and the second housing 252 are locked together by screws 26. The first housing 251 has an accommodating space for accommodating the rotor 22, and the second housing 252 has a barrel 2521. The stator 21 and the driving device 23 cover the barrel 2521. The shaft 221 of the rotor 22 penetrates through the barrel 2521 and protrudes from the second housing 252.

Furthermore, the motor 2 of the embodiment further includes two bearings 27a, 27b. The bearings 27a, 27b cover the shaft 221 and are disposed in the barrel 2521. In the embodiment, the bearings 27a, 27b can be oil bearings or ball bearings. In addition, the motor 2 of the embodiment further includes an elastic element 28, which provides pre-pressure to the bearing 27b and absorbs vibration caused by the operation of the motor 2. Furthermore, the motor 2 of the embodiment further includes a fixing element 29, which can fix the bearing 27b and resist the axial force.

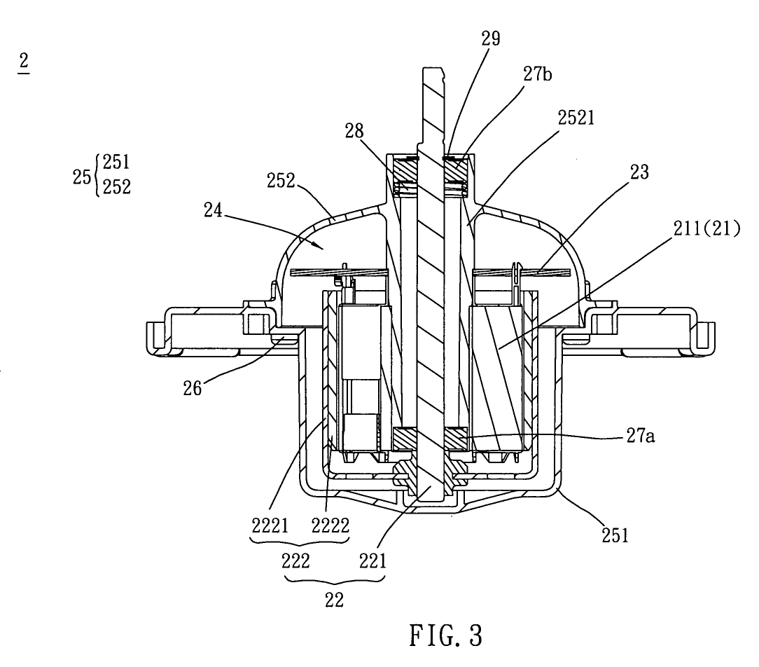

FIG. 3 is a sectional diagram of the assembled motor 2 shown in FIG. 2. In FIG. 3, the stator 21, rotor 22 and driving device 23 are disposed in a closed space 24 which is formed by a housing 25. Herein, the housing 25 is composed of the first housing 251 and the second housing 252. The barrel 2521 of the second housing 252 is inserted into the stator 21 and the driving device 23. The shaft 221 of the rotor 22 is inserted through the barrel 2521 and protrudes out of the housing 25. The part of the shaft 221, which protrudes out of the housing 25, is used to connect with the mechanism to be driven, which can be, but is not limited to, an impeller. In addition, the magnetic element 222 of the rotor 22 is disposed corresponding to the magnetically conductive element 211 of the stator 21. In this case, the magnetic element 222 of the rotor 22 is located around the magnetically conductive element 211 of the stator 21. Herein, the magnetic element 222 can be composed of a magnetically conductive shell 2221 and a magnet 2222, which is disposed on the inner wall of the magnetically conductive shell 2221. Therefore, by the alternating electric field provided by the driving device 23, the magnetic element 222 and the magnetically conductive element 211 can produce the alternating magnetic field, which can drive the rotor 22 to rotate.

In the embodiment, the shaft 221 is inserted into the bearings 27a, 27b. Moreover, the bearings 27a, 27b are disposed in the barrel 2521 and abut on two ends of the barrel 2521 to enable the smooth rotation of the shaft 221. The bearing 27b near the second housing 252 pressed axially urges against the elastic element 28 so that the elastic element 28 is fixed between the barrel 2521 and the bearing 27b to provide pre-pressure to the bearing 27b and absorb the vibration caused by the operation of the motor 2. Furthermore, the fixing element 29 is coupled to the shaft 221 and contacts the bearing 27b. In addition, in the embodiment, the fixing element 29 is wedged around the shaft 221 and against the bearing 27b to position the bearing 27b and resist the axial force.

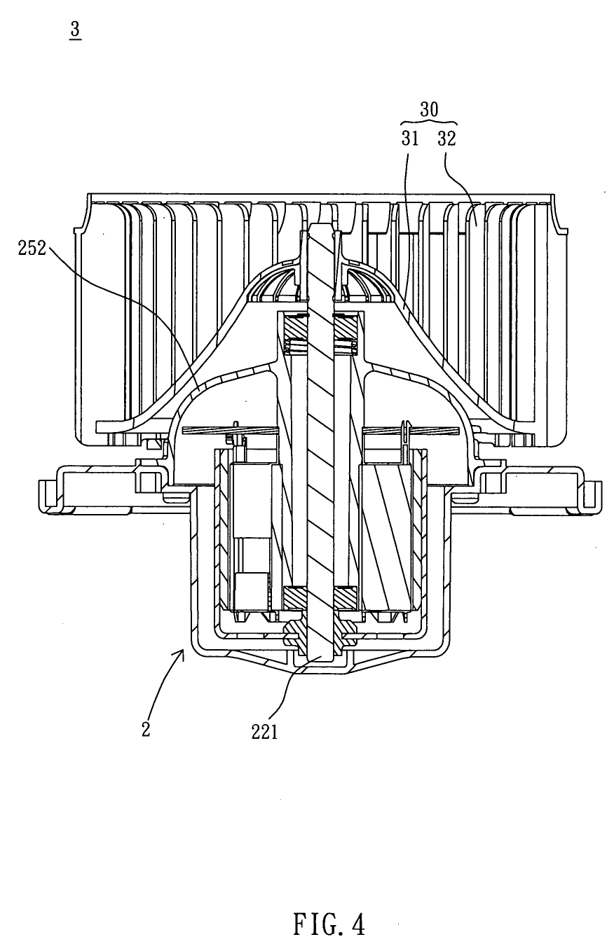

As shown in FIG. 4, a fan 3 according to an embodiment of the invention includes a motor 2 and an impeller 30. The motor 2 is illustrated FIG. 3 so the detailed descriptions thereof are omitted. The impeller 30 can be a centrifugal impeller or an axial impeller. In the embodiment, the impeller 30 is a centrifugal impeller. In addition, the fan 3 of the embodiment could be a fan for a vehicle.

The impeller 30 includes a hub 31 and a plurality of blades 32. The blades 32 are disposed around the hub 31, and the hub 31 is connected to the part of the shaft 221 protruding out of the second housing 252. Therefore, when the motor 2 operates, the impeller 30 can be driven to rotate and thus draw an airflow, which can, for example, dissipate heat.

In summary, the fan and motor of the invention include the stator, rotor and driving device, which are all disposed in a closed space composed of a housing. Compared with the prior art, the motor of the invention is more airtight so as to achieve the purpose of effectively protecting inner components of the motor and further increasing its reliability and lifespan.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor comprising:
a stator having a magnetically conductive element; and
a rotor having a shaft and a magnetic element, wherein the magnetic element is disposed corresponding to the magnetically conductive element,
wherein the stator and the rotor are disposed within a closed space, and the shaft protrudes out of the closed space.

2. The motor as recited in claim 1, wherein the closed space is formed by at least one housing.

3. The motor as recited in claim 2, wherein the housing is composed of a first housing and a second housing.

4. The motor as recited in claim 3, wherein the first housing and the second housing are assembled by wedging, engaging, adhering or locking.

5. The motor as recited in claim 3, wherein the second housing has a barrel, and the shaft is inserted into the barrel.

6. The motor as recited in claim 5, further comprising at least one bearing disposed within the barrel for supporting the shaft.

7. The motor as recited in claim 6, wherein the bearings are disposed at two ends of the barrel, respectively.

8. The motor as recited in claim 6, wherein the bearing axially urges against an elastic element.

9. The motor as recited in claim 6, further comprising a fixing element coupled to the shaft and contacting the bearing.

10. The motor as recited in claim 1, further comprising a driving device disposed within the closed space and electrically connected with the magnetically conductive element.

11. The motor as recited in claim 10, wherein the driving device comprises a circuit board.

12. A fan comprising:
a motor which comprising a stator and a rotor, wherein the stator has a magnetically conductive element, the rotor has a shaft and a magnetic element, and the magnetic element is disposed corresponding to the magnetically conductive element; and
an impeller coupled to the shaft,
wherein the stator and the rotor are disposed within a closed space, and the shaft protrudes out of the closed space.

13. The fan as recited in claim 12, wherein the closed space is formed by at least one housing.

14. The fan as recited in claim 13, wherein the housing is composed of a first housing and a second housing.

15. The fan as recited in claim 14, wherein the first housing and the second housing are assembled by wedging, engaging, adhering or locking.

16. The fan as recited in claim 14, wherein the second housing has a barrel, and the shaft is inserted into the barrel.

17. The fan as recited in claim 16, wherein the motor further comprises at least one bearing disposed within the barrel at on one end of the barrel.

18. The fan as recited in claim 17, where the bearing axially urges against an elastic element.

19. The fan as recited in claim 17, wherein the motor further comprises a fixing element coupled to the shaft and contacting the bearings.

20. The fan as recited in claim 12, wherein the motor further comprises a driving device within the closed space and electrically connected with the magnetically conductive element.
